(19) United States
(12) Patent Application Publication
(10) Pub. No.: US 2009/0070805 A1
(43) Pub. Date: Mar. 12, 2009

(54) METHOD AND SYSTEM FOR OPTIONAL SUPPRESSION OF TELEVISION BROADCAST LOW-PRIORITY GRAPHIC INTERRUPTIONS

(75) Inventors: David J. Delia, Lagrangeville, NY (US); Joseph J. Delia, Poughkeepsie, NY (US); Michael K. Delia, Lagrangeville, NY (US); Wayne M. Delia, Poughkeepsie, NY (US); Edward E. Kelley, Wappingers Falls, NY (US); Franco Motika, Hopewell Junction, NY (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/853,300

(22) Filed: Sep. 11, 2007

(51) Int. Cl. H04N 7/00

(52) U.S. Cl. 725/34

(57) ABSTRACT

A method for suppressing graphical overlays in video content, includes: generating a digital signal, the digital signal including a primary video feed subject to graphic overlays, a data stream, and an audio stream; wherein the primary video feed is; inserting steganographic information into the primary video feed; inserting alternative video information into the data stream; wherein the alternative video information is free of graphic overlays; substituting the alternative video information within the primary video feed based on the steganographic information; and wherein the substitution of the alternative video information suppresses at least a portion of the graphic overlay information.

### BACKGROUND OF THE INVENTION

1. Field of the Invention

This invention relates generally to television and multimedia devices, and more particularly to a method, apparatus, and system for providing subscriber based control over low priority graphics in a received digital broadcast signal.

2. Description of the Related Art

Digital television (DTV) is a telecommunication system for broadcasting and receiving moving pictures and sound by means of a digital signal, in contrast to an analog signal used by analog (traditional) TV. DTV utilizes the digital modulation of analog signal data, which is digitally compressed prior to recording or broadcast. The digitally compressed signal requires decoding by a specially designed receiver within a television set, or a standard receiver with a set-top box, or a PC fitted with a television card. Digital television has several advantages over traditional analog TV, the most significant being that digital channels take up less bandwidth space. The reduced bandwidth of a digital broadcast signal enables digital broadcasters to provide more digital channels in the same space, provide High-Definition (HD) digital service, or provide other non-television services such as pay-multimedia services or interactive services. Digital television also permits special services such as multicasting (more than one program on the same channel), electronic program guides, and program identification.

The Federal Communications Commission (FCC), the branch of the United States (U.S.) government that regulates the television and radio broadcast industries, has mandated that all U.S. television broadcasts will be exclusively digital as of Feb. 17, 2009. Furthermore, as of Mar. 1, 2007, all new television sets that can receive signals over-the-air, including pocket-sized portable televisions, must include digital or HDTV tuners so they can receive digital broadcasts.

FIG. 1 illustrates the primary components of a standard digital television broadcast signal 100. The signal 100 is composed of a primary video feed 102, an auxiliary data stream 104, and an audio stream 106. The digital broadcast signal 100 may be delivered utilizing, for example, over-the-air radio frequencies, coaxial cable, utility lines, fiber optics, and via satellite.

With the advent of digital television and more sophisticated video graphic generators, television broadcasters, television networks, and digital video service providers routinely insert reminders of upcoming programming schedules by way of briefly displayed graphics that occupy a portion of the video display. In addition, televised sporting events are cluttered with intrusive graphics of factoids that may or may not be entirely relevant to the game description. Although these graphics originated as small icons in the corner of the screen, or narrow informative crawls across the bottom of the screen, the graphics have expanded in size, duration, and now even have an audible component. Occasionally, information or images in the base video broadcast, such as the episode title, list of supporting actors, etc., are obscured behind the “pop-up” video graphics while they arc displayed.

The expansion of on-screen clutter is particularly prevalent in televised sports broadcasts. In between plays, between pitches, and during short timeouts, the commentary is supplemented by graphic displays which often take up most of the television screen, and in some instances, the graphic displays are accompanied by whooshing and science-fiction sound effects. Networks and digital service providers have determined that on screen overly displays and graphics that remind viewers of upcoming programs, program sponsors, and other informational messages during sporting events and general programming are worth a certain amount of indirect revenue per viewer.

### SUMMARY OF THE INVENTION

Embodiments of the present invention include a method, article, and system for suppressing graphical overlays in video content, the method includes: generating a digital signal, the digital signal including a primary video feed subject to graphic overlays, a data stream, and an audio stream; wherein the primary video feed is; inserting steganographic information into the primary video feed; inserting alternative video information into the data stream; wherein the alternative video information is free of graphic overlays; substituting the alternative video information within the primary video feed based on the steganographic information; and wherein the substitution of the alternative video information suppresses at least a portion of the graphic overlay information.

An article comprising one or more computer-readable storage media containing instructions that when executed enables the suppression of graphic overlays; wherein the method further includes: generating a digital signal, the digital signal including a primary video feed subject to graphic overlays, a data stream, and an audio stream; wherein the primary video feed is; inserting steganographic information into the primary video feed; inserting alternative video information into the data stream; wherein the alternative video information is free of graphic overlays; substituting the alternative video information within the primary video feed based on the steganographic information; and wherein the substitution of the alternative video information suppresses at least a portion of the graphic overlay information.

A system for suppressing graphic overlays in video content, the system includes: one or more receiving multimedia devices configured with decoding devices; one or more computer servers configured with software for implementing the graphic overlay suppression in a digital video signal for transmission by one or more transmitting means one or more storage devices for storing a database of subscriber information; one or more networks configured for signal communication of the digital video signal between the one or more transmitting means and the one or more receiving multimedia devices; wherein the digital signal comprises a primary video feed, a data stream, and an audio stream; wherein the primary video feed is subject to graphic overlays; wherein steganographic information is inserted into the primary video feed, and alternative video information is inserted into the data stream by the one or more computer servers; wherein the alternative video information is free of graphic overlays; wherein the decoding devices substitute the alternative video information within the primary video feed based on the steganographic information; and wherein the substitution of the alternative video information suppresses the graphic overlay information.

### TECHNICAL EFFECTS

As a result of the summarized invention, a solution is technically achieved for a method, article, and system for providing subscriber based control over low priority graphics in a received digital broadcast signal.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates the primary components of a standard digital television broadcast signal.

FIG. 2 illustrates the components of a digital broadcast signal that has been modified according to embodiments of the invention.

FIG. 3 is an operational block diagram of a video graphics suppression service according to embodiments of the invention.

FIG. 4 is a detailed operational block diagram for implementing subscriber-based suppression of low-priority video graphics according to embodiments of the invention.

FIG. 5 is an exemplary system for implementing embodiments of the invention.

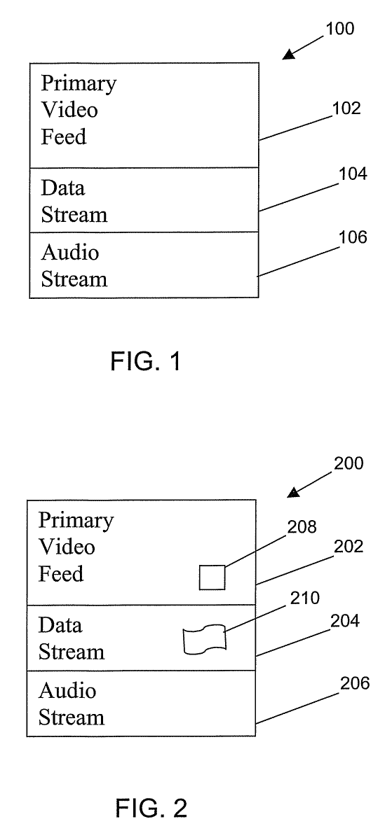

The detailed description explains the preferred embodiments of the invention, together with advantages and features, by way of example with reference to the drawings.

### DETAILED DESCRIPTION

Embodiments of the invention provide a method, article and system for the optional alteration of content in a digital television broadcast, typically for a fee paid by the viewer to receive the altered broadcast as a service. Currently, there arc no techniques available for eliminating the nonessential “pop-up” video graphics apart from turning off the television set entirely. Embodiments of the invention provide a mechanism for consumers to assert that they are capable of looking up upcoming programs for themselves in their cable or satellite guides, and that they arc willing to pay a premium price to suppress the intrusive graphics.

Embodiments of the invention suppress or eliminate graphical interruptions overlaid on a broadcast program, where the graphical overlays provide commercial ads, programming schedule information, or factoids while the broadcast program is in progress. The suppression of graphical overlays is accomplished by transmitting an unaltered sub-section of the display picture corresponding to the area of the broadcast program containing the overlaid graphical interruption. The additional video information associated with the unaltered subsection is included in the data stream of the digital broadcast, separate from the video stream. The additional bandwidth required to support the video feed for the unaltered sub-section is minimal compared to the full digital channel, since the graphical interruptions usually are temporary and the sub-section of the display area is usually not very large, making the overlay video segment small in size relative to the original broadcast stream. In addition, the compression schemes associated with digital transmission permits additional information to be transmitted with a minimal impact on overall bandwidth.

Embodiments of the invention employ the technique of steganography to encode graphical overlay information. Steganography refers to a technique of transmitting information that is encoded into an extremely small segment of a digital photo or a video stream. Pixels of photographic or video representations of images consist of bytes of information that produce the colors or shades of gray that make up the image itself Steganography takes a known location of one or more pixels in a digital image, and replaces the color specification information with alternate information, which is received and decoded. If the graphical overlay suppression service is subscribed to, or a viewer does not have a cable or satellite decoder box capable of detecting and decoding stenographic information, the image will not look substantially different as a result of the steganography information.

In embodiments of the invention, additional information is transmitted in the primary video feed using the technique of steganography along with the uncluttered sub-section of broadcast video display sent in the digital data stream. The additional information includes a program identifier key, which is used to compare to a flag stored in a cable, subscription service, or satellite decoder box, where the flag signifies whether a viewer has purchased the right to remove the graphical interruptions. In addition, the information transmitted using steganography includes a value for the start time and the duration of the graphical interruption, the width of the sub-section segment, the height of the sub-section segment, and the location of the upper left corner of the graphic, specified in pixels determining the horizontal and vertical displacement. If the viewer has paid for the graphics removal service, and the current program is identified as supporting this capability of removing graphical interruptions, the sub-sections of the digital broadcast containing the graphical interruptions are overlaid with the alternate video feed in the data stream, located at the designated positions and lasting for the designated time interval.

In embodiments of the invention, the optional removal of intrusive advertising graphics, “pop-up” program notification alerts, and other non-essential graphics may be made on a pay-per-view, pay-per-day, or monthly subscription basis. The subscription fee paid by viewers may be set to return more revenue to the networks and digital television service providers than the expected per-viewer benefit of the eliminated fee generating graphics. For example, if a network has determined that it is worth three-tenths of a cent per viewer for the network to show a graphic reminder of an upcoming program, the network or video content provider may allow the optional suppression of the graphic programming reminders to a subset of viewers who, in turn, are willing to pay a full cent not to see the proposed graphic alert during the show—returning seven-tenths of a cent of extra actual revenue for the privilege of viewing a broadcast program uninterrupted by these graphic alerts.

In embodiments of the invention certain essential or legally required pop-up graphics are retained on all broadcasts, such as civil defense alerts, parental guidance rating indicators, station identifier graphics, and weather alerts. In addition, certain unobtrusive graphics would also be retained, such as the small box or narrow crawl providing basic information for sports contests, such as the score, quarter, inning, time remaining, etc. Currently, there are no techniques available for eliminating the non-essential “pop-up” video graphics apart from turning off the television set entirely. This invention provides a way for consumers to assert that they arc capable of looking up upcoming programs for themselves in their cable or satellite guides, and that they are willing to pay a premium price to suppress the intrusive graphics.

FIG. 2 illustrates the components of a digital broadcast signal 200 that has been modified according to embodiments of the invention. Additional information 208 is transmitted in the primary video feed 202 using the technique of steganography along with the uncluttered sub-section of broadcast video display 210 sent in the digital data stream 204. The additional information 208 includes a program identifier key, which is used to compare to a flag stored in a cable, or satellite decoder box, where the flag signifies whether a viewer has purchased the right to remove the graphical interruptions. In addition, the information transmitted using steganography includes a value for the start time and the duration of the graphical interruption, the width of the sub-section segment, the height of the sub-section segment, and the location of the upper left corner of the graphic, specified in pixels determining the horizontal and vertical displacement. The audio stream 206 is not altered in embodiments of the invention.

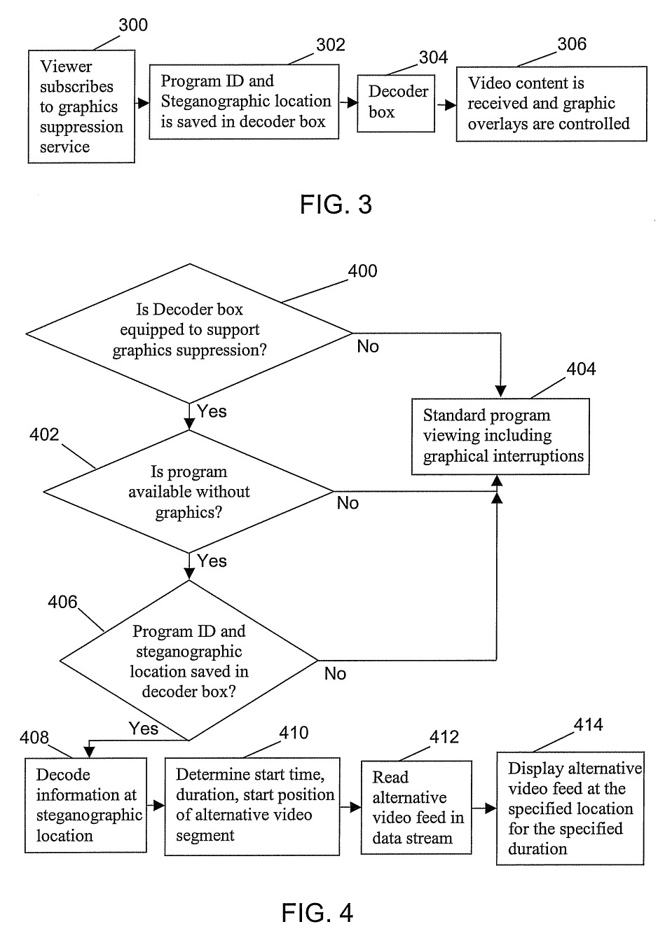

FIG.3 is an operational block diagram of a video graphics suppression service according to embodiments of the invention. The video graphics suppression service may be offered to subscribers on a subscription basis (block 300). Based on a subscription, program identification and stenographic information is loaded into the subscriber's decoder box (block 302 and 304). The decoder box 304 receives the video content and the graphic overlays are controlled (block 306).

FIG. 4 is a detailed operational block diagram for implementing subscriber-based suppression of low-priority video graphics according to embodiments of the invention. If a viewer's decoder box is not equipped to support graphics suppression (decision block 400 is No) or the program or video content is not available without graphics (decision block 402 is No), the viewer will receive standard programming including graphical interruptions (block 404). However, if the viewer's decoder box is equipped to support graphics suppression (decision block 400 is Yes) and the program or video content is available without graphics (decision block 402 is Yes), if the program ID and steganographic location information is saved in the viewer's decoder box (decision block 406 is Yes) the decoder box decodes information at identified steganographic locations (block 408). The decoder box determines the start time, duration, starting position of the alternative video segment (block 410), reads the alternative video feed in the data stream of the digital broadcast (block 412), and displays the alternative video feed at the specified location for the specified duration. If the program ID and steganographic location information is not saved in the viewer's decoder box (decision block 406 is No), standard program viewing including graphical interruptions (block 404) are displayed.

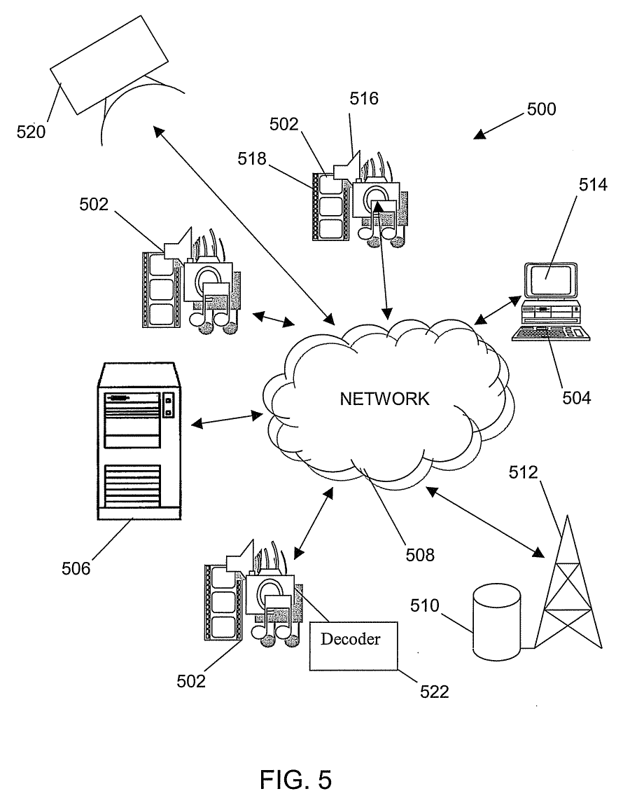

FIG. 5 illustrates an exemplary system 500 for implementing graphics suppression in digital video according to embodiments of the invention. The system 500 includes multimedia devices 502, and desktop computer devices 504 configured with digital video reception capabilities 514. The multimedia devices 502 may be digital televisions, and mobile communication and entertainment devices, such as cellular phones and mobile computing devices that are wirelessly connected to a network 508. The multimedia devices 502 have video displays 518 and audio outputs 516. The network 508 may be any type of known network including a fixed wire line network, cable and fiber optics, over the air broadcasts, satellite 520, local area network (LAN), wide area network (WAN), global network (e.g., Internet), intranet, etc. with data/Internet capabilities as represented by server 506. Communication aspects of the network are represented by cellular base station 512 and antenna 510. Decoders 522 may be externally connected to the multimedia devices 502 and desktop computers 504, integrated into the multimedia devices 502 and desktop computers 504, or contained on a smart card that is inserted into an available slot in the multimedia devices 502 and desktop computers 504.

User subscription profiles and databases for requesting and controlling graphics suppression may be resident on the individual multimedia devices 502 and desktop computers 504, or stored within the server 506 or cellular base station 510. The software for running the graphics suppression system may be resident on the server 506 or cellular base station 5 10.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for suppressing graphical overlays in video content, the method comprising:
generating a digital signal, the digital signal including a primary video feed subject to graphic overlays, a data stream, and an audio stream;
wherein the primary video feed is;
inserting steganographic information into the primary video feed;
inserting alternative video information into the data stream;
wherein the alternative video information is free of graphic overlays;
substituting the alternative video information within the primary video feed based on the steganographic information; and
wherein the substitution of the alternative video information suppresses at least a portion of the graphic overlay information.

2. The method of claim 1, wherein the steganographic information comprises a program identifier key and graphic overlay information.

3. The method of claim 2, wherein the program identifier key is compared to a flag in a subscriber decoder box to determine when to suppress the graphic overlays.

4. The method of claim 3, wherein the flag is set to suppress the graphic overlays based on a subscriber subscription status;
wherein the suppression of the graphic overlays is offered as a paid service to the subscriber; and
in response to a paid subscription graphic overlays are suppressed.

5. The method of claim 2, wherein the graphic overlay information includes a graphic's starting position, a graphic's width, a graphic's height, and a graphic's time duration.

6. An article comprising one or more computer-readable storage media containing instructions that when executed by a computer enables the suppression of graphic overlays; wherein the method further comprises:
generating a digital signal, the digital signal including a primary video feed subject to graphic overlays, a data stream, and an audio stream;
wherein the primary video feed is;
inserting steganographic information into the primary video feed;
inserting alternative video information into the data stream;
wherein the alternative video information is free of graphic overlays;
substituting the alternative video information within the primary video feed based on the steganographic information; and
wherein the substitution of the alternative video information suppresses at least a portion of the graphic overlay information.

7. The article of claim 6, wherein the steganographic information comprises a program identifier key and graphic overlay information.

8. The article of claim 7, wherein the program identifier key is compared to a flag in a subscriber decoder box to determine when to suppress the graphic overlays.

9. The article of claim 8, wherein the flag is set to suppress the graphic overlays based on a subscriber subscription status;
wherein the suppression of the graphic overlays is offered as a paid service to the subscriber; and
in response to a paid subscription graphic overlays are suppressed.

10. The article of claim 7, wherein the graphic overlay information includes a graphic's starting position, a graphic's width, a graphic's height, and a graphic's time duration.

11. A system for suppressing graphic overlays in video content, the system comprising:
one or more receiving multimedia devices configured with decoding devices;
one or more computer servers configured with software for implementing the graphic overlay suppression in a digital video signal for transmission by one or more transmitting means;
one or more storage devices for storing a database of subscriber information;
one or more networks configured for signal communication of the digital video signal between the one or more transmitting means and the one or more receiving multimedia devices;
wherein the digital signal comprises a primary video feed, a data stream, and an audio stream;
wherein the primary video feed is subject to graphic overlays;
wherein steganographic information is inserted into the primary video feed, and alternative video information is inserted into the data stream by the one or more computer servers;
wherein the alternative video information is free of graphic overlays;
wherein the decoding devices substitute the alternative video information within the primary video feed based on the steganographic information; and
wherein the substitution of the alternative video information suppresses the graphic overlay information.

12. The system of claim 11, wherein the steganographic information comprises a program identifier key and graphic overlay information.

13. The system of claim 12, wherein the program identifier key is compared to a flag in the decoder device to determine when to suppress the graphic overlays.

14. The system of claim 13, wherein the flag is set to suppress the graphic overlays based on a subscriber subscription status as stored in the one or more databases of subscriber information;
wherein the suppression of the graphic overlays is offered as a paid service to the subscriber; and
in response to a paid subscription graphic overlays are suppressed.

15. The system of claim 12, wherein the graphic overlay information includes a graphic's starting position, a graphic's width, a graphic's height, and a graphic's time duration.

16. The system of claim 11, wherein the receiving multimedia devices comprise one or more of: communication and entertainment devices, digital televisions, cellular phones, mobile computing devices, and desktop computers.

17. The system of claim 11, wherein the decoding devices are externally connected to the receiving multimedia devices.

18. The system of claim 11, wherein the decoding devices are integrated into the receiving multimedia devices.

19. The system of claim 11, wherein the decoding devices are contained on a smart card that is inserted into the receiving multimedia devices.

20. The system of claim 11, wherein the transmission means comprise one or more of: over the air broadcasts, cable television, satellite television, Internet, and cellular transmission.
